(19) United States
(12) Patent Application Publication
(10) Pub. No.: US 2026/0189102 A1
(43) Pub. Date: Jul. 2, 2026

(54) ELECTRIC MACHINE WITH INTEGRATED EDDY CURRENT BRAKE

(71) Applicant: Robert Bosch GmbH, Stuttgart (DE)

(72) Inventors: Laszlo Boros, Ludwigsburg (DE); Marcel Maier, Korntal-Muenchingen (DE); Rainer Walter, Pleidelsheim (DE); Simon Peter, Weil Der Stadt (DE)

(21) Appl. No.: 18/868,439

(22) PCT Filed: Apr. 20, 2023
(86) PCT No.: PCT/EP2023/060211

§ 371 Date: Nov. 22, 2024

(30) Foreign Application Priority Data
May 24, 2022 (DE) 10 2022 205 166.1

(51) Int. Cl. H02K 7/104; H02K 1/2793; H02K 7/00; H02K 49/04

(52) U.S. Cl. CPC H02K 7/104; H02K 1/2793; H02K 7/006; H02K 49/046

(57) ABSTRACT

The invention relates to an electric machine (24) comprising at least one disc-shaped rotor (58, 60) received on a shaft (52). The at least one disc-shaped rotor (58, 60) is provided with a brake disc (54) of an eddy current brake (22) on one side. The invention also relates to the use of the electric machine (24) with at least one integrated eddy current brake (22) as a central brake on a front axle (12) and/or a rear axle (38) of an electrically operated vehicle (10).

### BACKGROUND

The invention relates to an electric machine having at least one rotor received on a shaft. The invention also relates to the use of the electric machine with at least one integrated eddy current brake as a central brake on a front axle and/or a rear axle of an electrically operated vehicle.

DE 21 2014 000 218 U1 relates to a coupling device and a motor vehicle drive train. The drive train includes an internal combustion engine as well as an electric machine having a stator and a rotor, as well as a transmission device. A coupling device is arranged in the drive train between the internal combustion engine on the one hand, as well as the electric machine and the transmission device on the other. An actuation device comprises an electric eddy current brake having a brake stator and a brake rotor, the brake stator having an inner stator having a central coil.

DE 10 2018 201 689 A1 relates to a method for operating a brake system for a motor vehicle as well as a corresponding braking system. The brake system comprises an eddy current brake mechanically coupled to at least one wheel of the motor vehicle to provide a braking force acting on the wheel. An electric machine is mechanically coupled to, or couplable to, the wheel and electrically connected to the eddy current brake. It is provided that the eddy current brake is applied in parallel in an emergency braking operation mode to brake the wheel with energy supplied by the electric machine operated as a generator and electrical energy withdrawn from an energy store.

DE 10 2012 210 130 relates to a wheel drive unit for a wheel of an electrically operated vehicle. The wheel drive unit comprises an electric machine having a stator and a rotor rotatably mounted on the stator, and an electronic control device to control the electric machine and an eddy current brake via which the rotor can be braked. Due to the eddy current brake, no additional mechanical brake is required; power supply and control are provided by the existing power electronics of the electric machine. In one exemplary embodiment, the eddy current brake comprises a disc made of a metallic material, which is connected to the rotor in a rotationally fixed manner, extends in a radial direction perpendicular to an axis of rotation of the rotor, and in which eddy currents are generated to brake the rotor.

DE 10 2004 007 434 A1 relates to an electric motor having a rotor, a stator and a shaft arranged coaxially to an axis of rotation and having an eddy current brake having at least one brake magnet. The integration of an eddy current brake into an electric machine instead of the usual external brake for braking a motor is realized by using components already present in the electrical machine, at least in part. Preferably, the magnet of the eddy current brake is coupled to the rotor in a rotationally fixed manner and in particular comprises a magnetic ring that is arranged coaxially to the axis of rotation and attached to the rotor via a carrier component. The conductor of the eddy current brake is preferably formed by a fixed metal disc or flange.

DE 10 2009 006 196 A1 relates to a vehicle axis, which in one embodiment, is coupled to an electric machine and comprises an eddy current brake as a brake device.

Electrically operated vehicles brake primarily in a recuperative manner by means of the electric machine, which is operated in generator mode. Nevertheless, today's electrically operated vehicles are fitted with the same hydraulically actuated friction brakes as vehicles with an internal combustion engine. This is due to the fact that when braking at high speed, the electric machine is operated in the field attenuation range. This means that at high vehicle speeds, the braking torque of the electric machine operated in generator mode is typically not sufficient for emergency braking. With respect to availability, in contrast to a hydraulic brake system, it cannot be assumed that the electric machine operated in generator mode will always be able to provide the required braking torque.

### SUMMARY

According to the invention, an electric machine is proposed which has at least one disc-shaped rotor which is received on a shaft. The at least one disc-shaped rotor is provided with a brake disc of an eddy current brake on one side. The solution proposed according to the invention makes it possible to achieve in particular that, on the one hand, an eddy current brake can be integrated into the electric machine, i.e., it is associated with it in the sense of a central brake, and on the other hand, the solution proposed according to the invention makes it possible to use the at least one rotor used twice, for example in an electric machine configured as an axial flux machine. This means that the rotor serves on the one hand as a brake disc for the at least one eddy current brake and as a carrier for permanent magnets installed in, for example, an axial flux machine, on the other.

In an advantageous further development of the solution proposed according to the invention, the eddy current brake is integrated into a housing of the electric machine proposed according to the invention. This can save installation space and results in a particularly compact construction unit consisting of electric machine and eddy current brake.

In a further development of the electric machine proposed according to the invention, this is designed such that the eddy current brake is directly opposite the brake disc inside the housing on the at least one rotor of the electric machine.

One advantageous further development of the electric machine proposed according to the invention is that the eddy current brake comprises a plurality of coils distributed along its circumference, wherein the coils each comprise a winding and an iron core. Depending on the number of coils arranged around the circumference of the eddy current brake, the braking torque that can be generated can be set or predetermined.

In an advantageous embodiment of the electric machine proposed according to the invention, this comprises coils and at least one return element associated therewith.

In the electric machine proposed according to the invention, the brake disc at the rear of the at least one rotor is designed with a disc thickness of between 5 mm and 25 mm, preferably between 10 mm and 20 mm. The brake disc is manufactured from an electrically conductive and magnetically conductive material, such as cast iron. The thermal properties of the brake disc can be set via the disc thickness, i.e., it can be determined how much energy can be absorbed.

In a particularly advantageous further development of the electric machine proposed according to the invention, this electric machine, which is designed as an axial flux machine, for example, can be provided with a first rotor and a second rotor, each of which is disc-shaped and each of which is associated with an eddy current brake. In this embodiment, this results in a particularly compact design of an electric machine designed as an axial flux machine, for example, wherein in this case the rear sides of the two rotors which are substantially disc-shaped serve as brake discs for eddy current brakes.

In an advantageous further development of the electric machine proposed according to the invention, it is provided with a first and a second rotor, which, in the case of an axial flux machine, have magnets, in particular permanent magnets, on their sides facing each other.

In an advantageous further development of the electric machine proposed according to the invention, coils of the electric machine are arranged on the sides of the first and the second rotors, which are designed disc-shaped.

In the electric machine proposed according to the present invention, the coils of the electric machine each comprise a winding and an iron core. In the electric machine proposed according to the present invention, the shaft of the electric machine is connected either via a transmission or directly to at least one front wheel and/or at least one rear wheel of an electrically operated vehicle.

The invention also relates to the use of the electric machine with at least one integrated eddy current brake as a central brake on a front axle and/or a rear axle of an electrically operated vehicle.

The electric machine proposed according to the invention and the eddy current brake integrated into it make it possible to create a particularly compact central brake. The electric machine comprises at least one rotor, substantially as a disc-type, a number of magnets, which may be permanent magnets, for example. The advantages of an electric machine designed as an axial flux machine, for example, lie in its short design, which saves installation space, and in its high torque density. In the solution proposed according to the invention, the rear side of at least one rotor of the electric machine is used as a brake disc, so that this component can be used twice, whereby a considerable saving can be achieved in the material that would otherwise have to be used and the resulting weight and costs that would otherwise have to be incurred.

In advantageous embodiments, the very short electric machine can be accommodated in a housing, on the end faces of which, for example, an eddy current brake is accommodated, which interacts with a brake disc arranged at the rear of two rotors of the electric machine, wherein the rotors are connected to the shaft of the electric machine in a rotationally fixed manner.

This means that two eddy current brakes can be integrated into a housing of an electric machine without significantly increasing the housing length, so that a compact design is still given. In the electric machine proposed according to the invention, its shaft may either be connected to at least one front wheel or a rear wheel of an electrically operated vehicle with the interposition of a transmission, or the electric machine, which is designed as an axial flux machine, for example, may be directly connected to at least one wheel installed on the front axle and/or a rear axle of an electrically operated vehicle.

As already mentioned above, the electric machine with integrated eddy current brake proposed according to the invention may, for example, be designed as an axial flux machine comprising a number of magnets, in particular permanent magnets. It is of course possible to design the electric machine as a magnetic-free electric machine, for example as an asynchronous machine, reluctance machine or electrically excited synchronous machine. At least one eddy current brake may also be integrated into such types of electric machines.

### BRIEF DESCRIPTION OF THE DRAWINGS

Embodiments of the invention are described in greater detail hereinafter with reference to the drawings and the subsequent description.

Shown are:

FIG. 1 a schematic illustration of an electrically operated vehicle having an electric machine associated with a transmission and a eddy current brake, and

FIG. 2 a sectional view of a schematically illustrated electric machine, shown here for example as an axial flux machine, in whose housing an eddy current brake is integrated.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

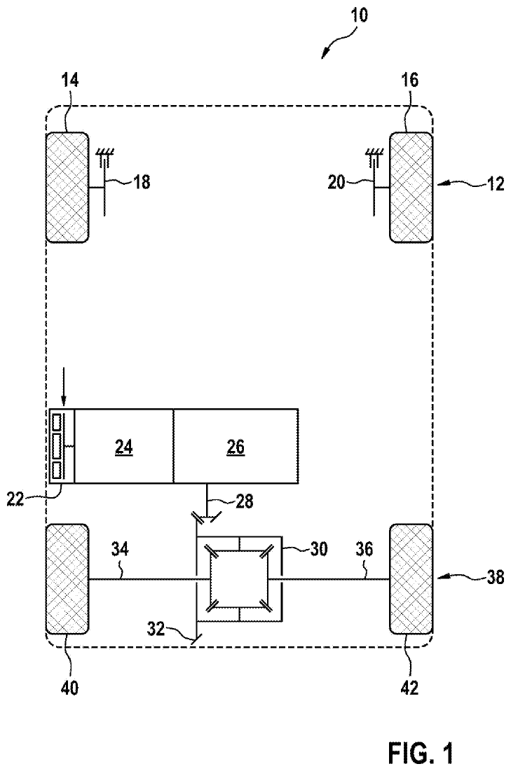

FIG. 1 shows an electrically operated vehicle 10 comprising a front axle 12 and a rear axle 38. A left front wheel 14 and a right front wheel 16 are received on the front axle 12, to each of which a left wheel brake 18 and a right wheel brake 20 are associated. The wheel brakes 18, 20 are conventional, hydraulically actuated service brakes. The electrically operated vehicle 10 further comprises an eddy current brake 22 associated with an electric machine 24. A transmission 26 is also associated with this, which comprises an output 28. The transmission 26 drives a differential wheel 32 of a differential 30 via its output 28.

To the side of the differential 30, a first output shaft 34 extends to a left rear wheel 40, and a second output shaft 36 to a right rear wheel 42. The two output shafts 34, 36 form the rear axle 38 of the electrically operated vehicle. In contrast to the front axle 12, no service brakes are arranged on the rear axle 38 of the electrically operated vehicle 10, as shown in FIG. 1. The function of a central brake in relation to the rear axle 38 is performed by the eddy current brake 22 associated with electric machine 24. The electric machine 24 of the electrically operated vehicle 10 according to the schematic illustration in FIG. 1 is operated in the motor mode via power electronics not shown in detail herein; furthermore, a braking torque is generated in recuperation mode of the electric machine 24 by operating it in the generator mode. The transmission 26, via which the differential 30 is driven, is not absolutely necessary.

For example, the electrically operated vehicle 10 shown in FIG. 1 is one in which the electric machine 24 is designed in the form of an axial flux machine 48. An axial flux machine 48 is characterized by a short design and very high torque density. The electric machine 24 may alternatively also be a magnet-free electric machine, such as an asynchronous machine, a reluctance machine, or an electrically excited synchronous machine. Thus, a large number of machine types of the solution proposed according to the present invention are accessible.

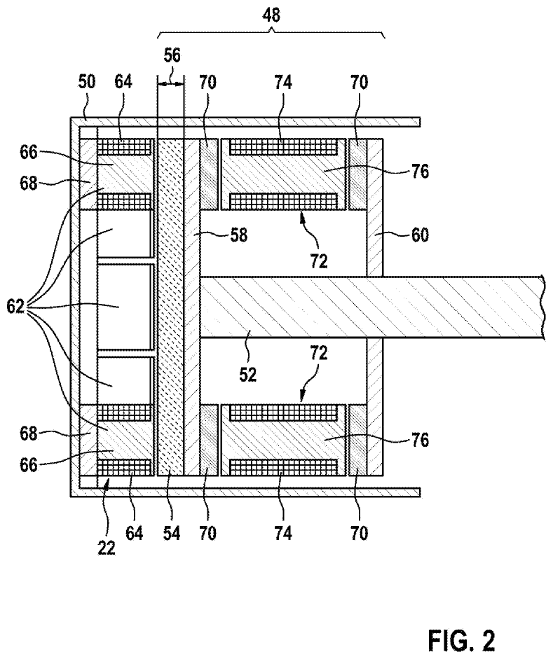

Based on FIG. 2, the electric machine 24 proposed according to the invention is described in more detail. According to FIG. 2, this is designed as an axial flux machine.

From the illustration according to FIG. 2 it can be seen that the electric machine 24 comprises a housing 50. The eddy current brake 22 is integrated into the housing 50 of the electric machine 24 configured herein as the axial flux machine 48. At least a first rotor 58 is received on a shaft 52 of the electric machine 24 configured herein as an axial flux machine 48. Magnets, in particular permanent magnets 70, are arranged on one side of the first rotor 58 of the axial flux machine 48. A brake disc 54 of the eddy current brake 22 integrated into the housing 50 of the axial flux machine 48 is located on the rear side of the substantially disc-shaped first rotor 58. From the illustration according to FIG. 2, it can be seen that the brake disc 54 has a disc thickness 56. The thickness of the brake disc 54 is in a range between 5 mm and 25 mm, preferably between 10 mm and 20 mm. The thickness of the brake disc 54 is particularly relevant for its thermal properties, as it determines the thermal mass and therefore how much energy can be absorbed. In one embodiment, the disc thickness of the brake disc 54 is 15 mm. The material from which the brake disc 54 is fabricated is a material that is both electrically and magnetically conductive. The speed range is set via the electrical conductivity. Cast iron, for example, offers optimum electrical conductivity.

FIG. 2 also shows that the eddy current brake 22 included in the housing 50 of the axial flux machine 48, as exemplified herein, comprises a number of coils 62. The coils 62 are arranged along the circumference of the eddy current brake 22 and each comprise a coil 64 extending around an iron core 66 receiving the winding 64. The coils 62 are associated with a return element 68. The end face of the eddy current brake 22 is located at a short distance from the end face of the brake disc 54, which is received on the rear of the first rotor 58.

The axial flux machine 48, as exemplified herein, according to the sectional view in FIG. 2, also shows that a second rotor 60 is received on the shaft 52 of the axial flux machine 48. On the side of the second rotor 60 facing the permanent magnets 70 of the first rotor 58, permanent magnets 70 are also arranged distributed around its circumference, the number of which corresponds to the number of permanent magnets 70 received on the corresponding side of the first rotor 58. Coils 72 of the electric machine 24, which in this example is designed as an axial flux machine 48, run between the respective permanent magnets 70 on the sides of the first rotor 58 and the second rotor 60 facing each other. Each of the coils 72 of the electric machine 24 configured as an axial flux machine 48 comprises a winding 74 received on a corresponding iron core 76. The number of coils 72 of the electric machine 24, which in this example is designed as an axial flux machine 48, corresponds to the pairs of opposing permanent magnets 70 on the opposite sides of the first rotor 58 and the second rotor 60.

The second shaft 52 of the axial flux machine 48, shown broken off in FIG. 2, is either connected to at least one front wheel 14, 16 of the electrically operated vehicle 10 by interposing the transmission 26 schematically indicated in FIG. 1, or is connected directly to at least one front wheel 14, 16 of the front axle 12 and/or at least one rear wheel 40, 42 on the rear axle 38, which is formed by the first output shaft 34 and the second output shaft 36.

In the illustration according to FIG. 2, the eddy current brake 22 is integrated into the housing 50, in particular associated with its end face. As an alternative to the embodiment shown in FIG. 2, it is possible to also attach a brake disc 54 to the rear of the second rotor 60 and to provide a further eddy current brake 22 integrated into the housing 50 opposite it in the part of the housing 50 not shown. Thus, the axial length of the axial flux machine 48 is not significantly increased, so that there are no disadvantages regarding the installation space requirements, but there is the advantage of a high power density and a high braking torque setting.

As a result of the solution proposed according to the invention, one and the same component, i.e. the first rotor 58 and possibly also the second rotor 60, which are associated with the shaft 52 in a rotationally fixed manner, can be used in two ways as shown in FIG. 2: On the one hand, the sides of the first rotor 58 and the second rotor 60 facing each other serve to receive the permanent magnets 70, between which the coils 72 of the electric machine 24, which is designed as an axial flux machine 48, extend. On the other hand, brake discs 54 of eddy current brakes 22 associated with the first rotor 58 and, if necessary, the second rotor 60 can be arranged on the rear of these. This results in significant material savings through dual use of the rotors 58, 60 and thus a significant reduction in cost and weight.

Furthermore, the invention relates to the use of the electric machine 24, as exemplified herein as an axial flux machine 48, in the electrically driven vehicle 10. The electric machine 24, designed here as an axial flow machine 48, is characterized by a high power density and a short axial design. If, in addition, at least one eddy current brake 22 is integrated into the housing 50 of the axial flux machine 48 in accordance with the solution proposed according to the invention, this results in a compact structural unit which, in addition to a high torque density and thus a high performance, is also capable of applying a high torque as a central brake, for example on the rear axle 38 of the electrically operated vehicle 10 shown schematically in FIG. 1.

The invention is not limited to the exemplary embodiments described herein and the aspects highlighted thereby. Rather, within the range specified by the claims, a plurality of modifications is possible, which lie within the abilities of a skilled person.

1. An electric machine (24) comprising at least one disc-shaped rotor (58, 60) received on a shaft (52), wherein the at least one disc-shaped rotor (58, 60) is provided with a brake disc (54) of an eddy current brake (22) on one side.

2. The electric machine (24) according to claim 1, wherein the eddy current brake (22) is integrated into a housing (50) of the electric machine (24).

3. The electric machine (24) according to claim 1, wherein the eddy current brake (22) of the brake disc (54) within the housing (50) is opposite the at least one rotor (58, 60).

4. The electric machine (24) according to claim 1, wherein the eddy current brake (22) comprises a plurality of coils (62) distributed along its circumference, each comprising a winding (64) and an iron core (66).

5. The electric machine (24) according to claim 4, wherein each of the coils (62) is associated with a return element (68).

6. The electric machine (24) according to claim 1, wherein the brake disc (54) has a disc thickness (56) of between 5 mm and 25 mm, and is made of an electrically and magnetically conductive material.

7. The electric machine (24) according to claim 1, wherein the electric machine (24) comprises a first rotor (58) and a second rotor (60), each of which is disc-shaped and each of which is associated with an eddy current brake (22).

8. The electric machine (24) according to claim 1, wherein the electric machine (24) comprises a first and a second rotor (58, 60) which have permanent magnets (70), on their sides facing one another.

9. The electric machine (24) according to claim 8, wherein coils (72) of the electric machine (24), configured as an axial flux machine (48), are arranged on the sides of the first rotor (58) and of the second rotor (60), which are disc-shaped, between permanent magnets (70), which are opposite each other.

10. The electric machine (24) according to claim 1, wherein the coils (72) of the electric machine (24) comprise a winding (74) and an iron core (76).

11. The electric machine (24) according to claim 1, wherein the shaft (52) of the electric machine (24) is connected via a transmission (26) or directly to at least one front wheel (14, 16) and/or at least one rear wheel (40, 42) of an electrically operated vehicle (10).

12. A use of the electric machine (24) according to claim 1 with at least one integrated eddy current brake (22) as a central brake on a front axle (12) and/or a rear axle (38) of an electrically operated vehicle (10).
